(19) United States
(12) Patent Application Publication
(10) Pub. No.: US 2026/0102737 A1
(43) Pub. Date: Apr. 16, 2026

(54) APPARATUS FOR THE ABATEMENT OF POLLUTANTS IN CONFINED SPACES USING MICROORGANISMS AND THEIR ABATEMENT PROCESS

(71) Applicant: Stefano Ragini, Serravalle (IT)

(72) Inventors: Stefano Ragini, Serravalle (IT); Claudio Montanari, Settimo (IT)

(73) Assignee: Stefano Ragini, Serravalle (IT)

(21) Appl. No.: 19/114,674

(22) PCT Filed: Oct. 3, 2023
(86) PCT No.: PCT/IB2023/059892

§ 371 Date: Mar. 24, 2025

(30) Foreign Application Priority Data
Oct. 4, 2022 (IT) 102022000020346

(51) Int. Cl. B01D 53/84; A01K 1/00; B01D 53/76

(52) U.S. Cl. CPC B01D 53/84; A01K 1/0047; B01D 53/76; B01D 2258/0266

(57) ABSTRACT

A pollutant abatement process includes providing a confined environment containing the pollutants to be abated at least in volatile form and conveying a plurality of microorganism into the confined environment using a dry mist produced by molecular fragmentation as a vector. The process is particularly suited to abate of manure gas at a livestock farm, but is also applicable to other environments. The process also concerns a related abatement device and a related environment, such as a livestock site, containing such a device.

### DESCRIPTION

The present invention relates to an apparatus for abatement of noxious substances in confined environments, especially volatiles, such as gases, using microorganisms, such as bacteria. The invention is made with particular reference to the abatement of manure gas in livestock farms, however, other uses are not excluded. The invention also relates to a confined site comprising said apparatus and a related abatement process. The invention is particularly suited to poultry farming, for example of chickens, but is applicable to the farming of any type of animal.

### PRIOR ART

Manure gases are one of the main problems afflicting both intensive and non-intensive livestock farming, with animals raised inside sheds or in general in closed environments, to the point that there are very specific and increasingly demanding regulations for their abatement.

Suffice it to know that these gases contain high percentages of ammonia methane gas and CO2.

Today, the sheds are chemically sanitised before the animals are brought in, as any subsequent access by personnel is strictly restricted for health reasons. This, however, is of no help in the abatement of gases, and in any case forces the sheds to be equipped with large ventilation systems that change the air when a certain level of gas is reached, and which in practice are always active. Such systems exert a serious form of pollution on the environment as they release harmful gases into the air. In addition, the exchange of air requires pre-heating or cooling depending on the season, thus forcing high energy consumption.

In any case, all this is only a palliative and does not reduce the tendency of animals to fall ill due to farming conditions, so that it is in fact not uncommon for an entire batch of animals to have to be slaughtered and destroyed, or for farms to be forced to make extensive use of antibiotics, including organic farms.

An initial attempt to solve the problem is known in the patent literature from documents D1-KR101895039, D2-KR102162543, D3-EP1834522, D4-DE102019104804.

They express the embryonic idea of abating manure gases by exposing them to the action of bacteria which saturate the farming environment through a mist.

In principle, this procedure is promising, but the fact that it has been known since at least 2007 and has been patented again and again over the years, without, however, finding practical application in animal farming, is an indication that the characteristics that can make it truly effective and applicable have not yet been codified.

For example, known documents propose the use of mists with low fragmentation and therefore wetting, the use of fermentation tanks, and the heating of bacteria mixtures in tanks.

Following careful experimentation, the applicants discovered that all these patented practices, which were thought to increase the beneficial effect, may in fact be detrimental, if not downright negative. In fact, they do not preserve the vitality of the bacteria, but stress them, making them inactive at the time of use or even putrefying.

Furthermore, it is found that known documents indicate a continuous flow of production from continuously fed tanks, so it is not possible, or least not easy, to accurately quantify the treatments carried out, which at the level of health regulations is now mandatory, at least in some countries, at least for livestock farms.

Finally, it is noted that in the case of mite-infested farms, such as laying hen farms, treatment with bacteria is not sufficient to destroy the mites, and therefore it is customary to vaccinate eggs doing microinjections into the eggs themselves.

As an alternative to treatment procedures with bacteria, it is known to use disinfectants, such as chloramines, sent through molecular fragmentation dry mist. This, however, is a deviation by incompatibility from the use of bacteria, as its purpose is to kill them. Furthermore, it is not possible to carry out treatments in the presence of living animals or people, so the treatments cannot be repeated during farming and are therefore ineffective.

The purpose of the present invention is to completely or partially overcome the problems of the prior art.

Another purpose of the present invention is to improve animal or human welfare and health within livestock farming in confined environments.

A further purpose of the present invention is to increase animal welfare by limiting the need for operators to access livestock sites.

Another further purpose of the present invention is to increase animal welfare by limiting energy consumption within livestock sites.

A further preferred purpose of the present invention is to provide an apparatus for the abatement of manure gas in livestock farms, or in general of volatile pollutants in confined environments, that is reliable, easy to use and relatively inexpensive to implement.

A further purpose of the present invention is to enable the use of regenerative microorganisms, e.g. regenerative bacteria, to abate gases by keeping them active and vital until use.

Another purpose of the present invention is enabling effective treatments even in presence of living animals or people.

A further purpose of the present invention is to allow easy quantification and traceability of the treatments performed.

A further purpose of the present invention is to eradicate mites from a confined environment without the use of drugs.

### GENERAL INTRODUCTION

According to its first general aspect, the present invention concerns a volatile pollutants abatement process characterised by the fact that it comprises the following steps:
providing a confined environment containing the pollutants to be abated at least in volatile form
conveying a plurality of microorganisms into the confined environment using a dry mist produced by molecular fragmentation as a vector.

In spite of the known technique that reserves molecular fragmentation for the use of disinfectants to abate the bacterial load on surfaces, it proves to be very advantageous for transporting the bacteria themselves to perform a volatile pollutant abatement action. In particular, fragmentation, although a very thorough process, does not harm the bacteria, and indeed maintains their full vitality. In addition, this fragmented mist is very less wetting and more volatile than the other mists of the prior art, even if ultra fine, so it remains in a volatile condition for longer. It is noted that in general the use in combination with known disinfectants is known not so much for staying in a volatile state, but rather for allowing deeper penetration of surfaces.

According to some preferred forms of implementation, the process involves the following steps:
providing at least a sealed biosolution container and a water source, where the biosolution includes said microorganisms suspended in a liquid containing at least their nutrients, where preferably the minimum concentration of microorganisms is around 107,
   opening the container and mixing the said biosolution and the said water substantially at the time when generating said mist.

In this way, the viability of the microorganisms is advantageously maintained, in contrast to the prior art, which contemplates containers in which they are even fermented or continuously fed during use. It is also noted that the containers of the prior art are devoid of biosolution with nutrients, as they do not aim for the maintenance of the bacteria but for their maximum activation, which, however, being premature, ends up diminishing the effect.

This also allows for the subdivision and precision of the dosages of each treatment, which can, for example, be tracked by reading devices of recognition means affixed to each sealed container.

According to some preferred forms of implementation, it is possible to condition the mist to favour the effect of the microorganisms without damaging their vitality by intervening on the water or air in which the mist is produced, and not on the microorganisms, unlike the prior art that, on the contrary, heats the mixture to favour fermentation.

The present invention otherwise heats a mist expulsion air stream, and/or treats the water by electromagnetism or hydrogenation before mixing with the biosolution.

According to some preferred forms of implementation, the present invention makes use of mist as a carrier to send said microorganisms and at least one essential oil into the same environment in two successive treatments respectively. The two treatments are synergistic with each other in that the essential oil finds the mites weakened by the microorganisms and is therefore able to kill them permanently. This is useful, for example, in laying hen farms, and avoids the need for vaccination of the produced eggs.

### DETAILED DESCRIPTION

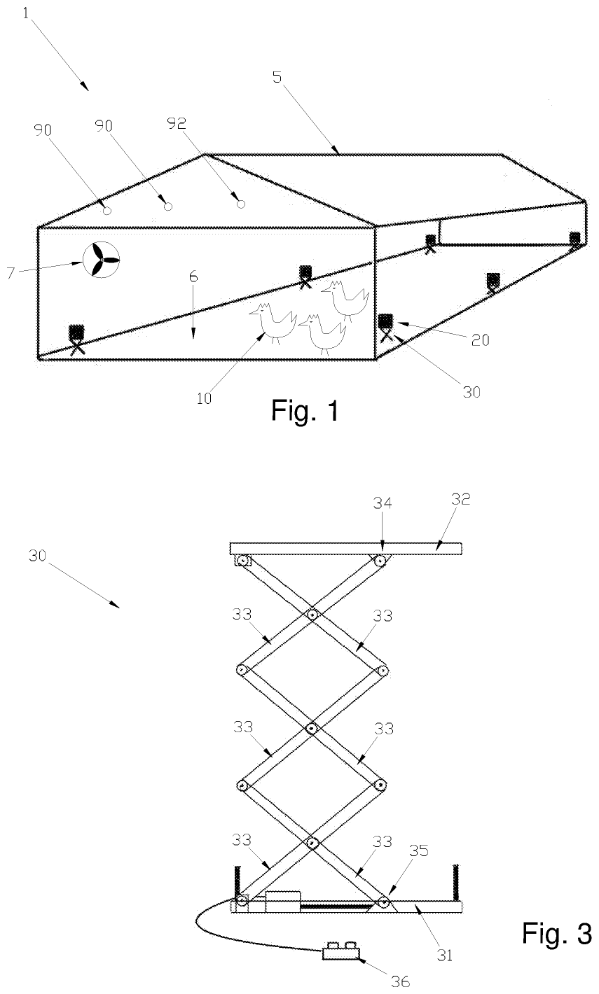

Further features and advantages of the present invention will best be seen from the following detailed description of preferred implementation forms of the invention, made with reference to the accompanying drawings, exemplifying but not limitative. In said drawings:
FIG. 1 schematically shows a livestock farm according to the present invention;

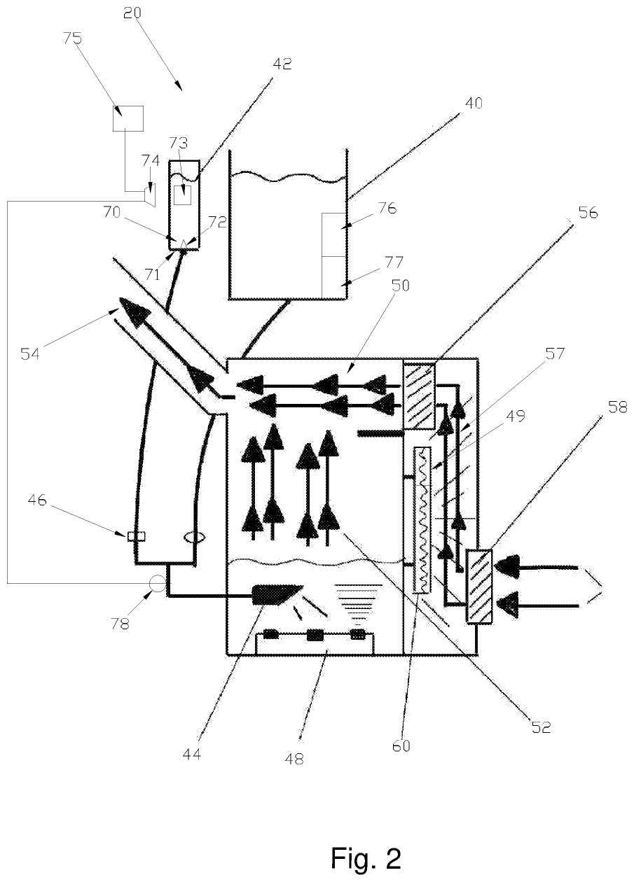

FIG. 2 shows an apparatus for the abatement of manure gas in livestock farms according to the present invention;

FIG. 3 shows a lifting device of the gas abatement apparatus of FIG. 2. With reference to FIG. 1, a livestock farm is schematically shown according to the present invention generally indicated with reference number 1;

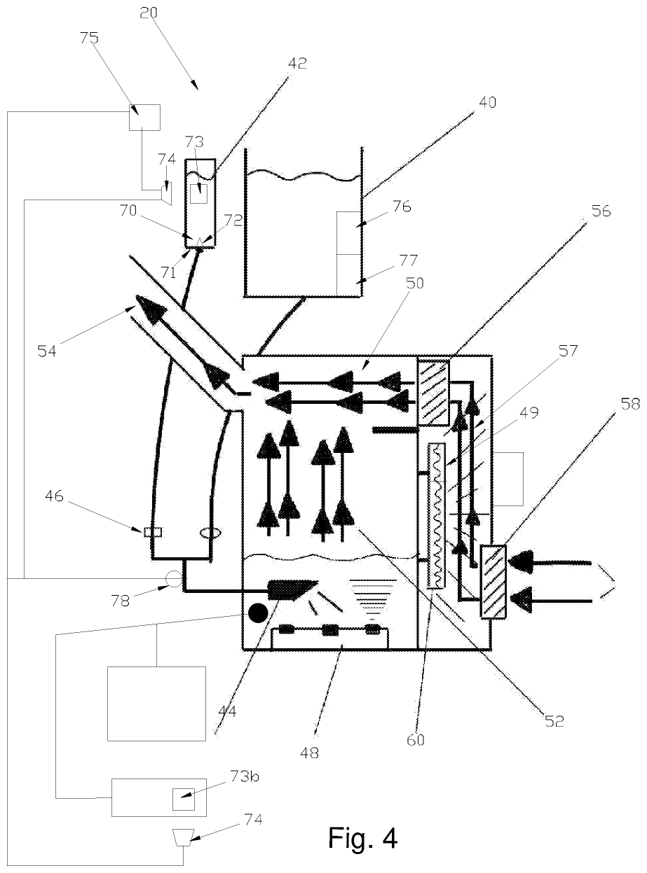

FIG. 4 shows a further way of implementation of an abatement apparatus according to the present invention

The site comprises:
a confined environment, for example a shed 5 configured to contain a plurality of living animals;
a plurality of living animals 10 inside the confined environment during the abatement of manure gases, as it will be described later;
at least one manure gases abatement apparatus in livestock farms, hereinafter referred to as abatement apparatus 20 for brevity.

Preferably site 1 comprises a plurality of abatement apparatuses 20.

At least one abatement apparatus 20 is supported on a corresponding lifting device 30.

Preferably the farm 1 1 comprises a floor 6 on which the animals are stationed and on which the lifting devices 30 are supported.

Preferably, the site 1 also comprises a ventilation system 7 of the shed 5.

The abatement apparatus comprises:
a mist generating device 48
at least one water source 40 containing water, or another water source, to feed said mist generating device 48;
at least a sealed micoorganisms container 42, including said microorganisms suspended in a liquid containing at least their nutrients, where the combination of the microorganisms and the suspension liquid is called “biosolution” for brevity. The microorganisms are of the regenerative type. The sealed container is placed to feed said dry mist generating device, wherein the apparatus 20 comprises opening means 70 of said sealed container. For example, the sealed container comprises a sealing diaphragm 71 and the opening means comprise perforation means 72 of said diaphragm associated with the mist generating device 48. Alternatively, the opening means 70 comprise a removable cap.

The biosolution, for example, contains at least bacteria and yeasts in a suspension liquid, where the minimum concentration of microorganisms is about 107.

The micoorganisms container 42 can be coupled and decoupled from the abatement apparatus 20, e.g. it is a vial or bottle, equipped with recognition means 73, e.g. a QR code, configured to be read by a reader device 74 of the abatement apparatus, which in turn is operatively connected to consensus means 78 set up to allow or deny operation based on the performed reading.

It is also possible to provide recording means 75 in operational connection with said reader device 74 to record data related said reading and maintain traceability of treatments carried out on batches of animals.

Preferably, it is possible to set up a plurality of sealed containers 42, each identified by its own means of identification 73, so that following treatments can be authorised and tracked simply by replacing the used container 42 with a new one each time.

Tank 40 and container 42 are connected to a mixing device 44 by specific pipes. The abatement apparatus also includes at least one dosing device 46 configured to dose the amount of biosolution to be mixed with water.

The mixer 44 delivers the mixture of biosolution and water to the mist generating device 48, which is configured to perform molecular fragmentation of said mixture, e.g., into micrometer-sized particles, more preferably substantially of 5 microns or less.

At this size, the mist can be defined as dry mist, i.e. without a substantial wetting effect.

Preferably, dry mist generating device performs molecular fragmentation by vibration.

In addition, the abatement apparatus comprises a forced-air mist ejection line 50, in particular said line 50 comprises a mist containment compartment 52 interposed between an outlet 54 from the compartment and an ejection fan 56. Thanks to this arrangement, the fan is less attacked by the mist.

In addition, the outlet 54 and the fan 56 are placed in the upper part of the compartment 52, while dry mist generating device is in the lower part. Thanks to this arrangement the mist pushed out by the flow of the fan generates a depression which sucks the lighter and therefore more volatile mist particles from the compartment 52, which favours their diffusion and the reduction of the wetting effect at the sites.

The ejection fan 56 draws air from a sanitising section 57 arranged before contact with the mist and comprising an inlet HEPA filter 58 and a UV lamp 60.

Conveniently, the microorganisms are mixed with water only at the time of use, so they are preserved from decay due to putrefaction from long standing in water. The dry mist acts as a carrier for the microorganisms thus preserved. In addition, the microorganisms are not damaged by the micrometric size of the fractionation to obtain the mist. Finally, the air used to expel the dry mist is sanitised by a HEPA filter and UV lamp, thus further preserving the microorganisms, which are therefore released into the site at their maximum active condition.

Preferably, the apparatus 20 comprises heating means 49 configured to heat the mist ejection air or the mist itself. In the case of heating the ejection air, the heating means 49 are preferably located on the upper part of the ejection fan 56, for example in the sanitisation section 57.

Preferably, heating means heat the air or mist to a temperature preferably between 20 and 40° C., as this is an ideal range for the life of microorganisms.

Preferably the apparatus 20 comprises water electromagnetic treatment means 76 placed before mixing with said biosolution, e.g. near container 40 or relative pipes. Conveniently, at least a desired frequency is imprinted into the water in this way, thanks to the well-known water memory or harmonisation effect.

Preferably the apparatus 20 comprises water electromagnetic treatment means 77 placed before mixing with said biosolution, e.g. near container 40 or relative pipes. Conveniently, the water used for the mist will result hydrogenated, without the treatment damaging the microorganisms.

The site may comprise a manure gas concentration sensor 92, for example an ammonia sensor, placed within the shed, by means of which it activates or stops mist production based on a predetermined concentration level of manure gas. Said sensor 92 is hereafter also called a gas sensor for mist distribution.

The site may comprise in addition to the gas concentration sensor 92 at least one humidity sensor 90, e.g. a hygrometer, placed inside the shed, through which it activates or stops mist production based on a predetermined humidity level. The sensor 90 for example is in radio connection with the abatement apparatus 20.

Consider that the action of microorganisms on gases is not immediate, but requires a certain amount of time and a certain concentration of microorganisms to become stable. Therefore, when the site already contains a high number of microorganisms, the on/off function of the abatement devices can be performed by the manure gas sensors, in order to send to the site sufficient mist to generate a maintenance effect.

In the initial phase, however, when there are still no microorganisms at the site, the mere control through the gas sensors could lead to too high concentrations of both microorganisms and humidity, so it is best to stop mist production before the desired gas abatement is reached and when a predetermined humidity detected by the mist concentration sensors is reached instead (90).

In site 1, the abatement devices 20 are preferably supported by corresponding lifting devices 30, by means of which they can be lifted and lowered in reference to the floor 6 on command.

The advantage is that during use they can be kept in an elevated position, which is more favourable to mist dispersion, prevents animals from reaching the abatement apparatus and dirtying it, thus helping to keep it efficient, especially it is equipped with sensors, remote control and data transmission tools.

It is then periodically possible to lower the abatement devices 20 to ground level for maintenance and/or replacement of the sealed biosolution container 42 and for filling the tank 40, if any.

FIG. 3 shows, by way of example, a lifting device 30 comprising a base on the ground 31, a platform 32 that can be lifted and lowered in reference to it by means of an articulated arm mechanism 33 interposed between them.

The articulated arm mechanism comprises a plurality of stages each comprising a pair of arms 34 crossed over each other and movable relative to each other to vary the angle between them on command. Essentially, they form a bellows mechanism.

The end 34 of a first arm 33 is constrained movable in horizontal sliding to the platform 32, and an end 35 of a second arm 33 is constrained movable in horizontal sliding to the base 31.

The lifting device is completed by a foot control 36 through which lifting and lowering is activated.

The farming site 1 may be supplemented by at least one manure gases saturation sensor 94 placed within the shed which enables or denies operation of the ventilation system 7, and referred to hereafter as gas sensor for ventilation. This sensor is preferably distinct from the gas sensor 92 for mist distribution.

In use, it is possible to implement a manure gas abatement process comprising the following steps:
set up an abatement apparatus of the type indicated above;
introduce the animals in the site 1
treat the site during the presence of the animals generating the mist containing the microorganisms by means of the abatement apparatus 20.

Experimental tests demonstrated the conspicuous reduction or absence of starting the aeration system 7, proving that the abatement of manure gases is effective, and with the advantage of reducing energy costs for operating the site.

In addition, animals, given the same diet, have shown to be healthier and to be growing more due to better environment conditions.

Conveniently, machine management can be carried out completely remotely by providing special sensors and data communication modules on the abatement apparatus 20, thus limiting operator access to the site in the presence of animals to only the need to replace the sealed biosolution containers 42 and any eventual refilling of the tank 40.

With reference to FIG. 3, a further form of implementation of the invention will now be described where identical or similar elements will be indicated by the same reference numbers used above, or by the same numbers increased by 100.

The apparatus of FIG. 4 is referred to as a whole by reference number 120 and differs from apparatus 20 in the fact that it additionally comprises at least one container of essential oil 95, effectively connected or connectable to the dry mist generating device 49.

The apparatus 120 comprises at least processor means 98 and memory means 99 where in the latter are stored at least one piece of program executable by the processor means configured to execute successively at least one treatment with dry mist and microorganisms and one treatment with dry mist and essential oil.

In order to generate the dry mist with essential oil, the apparatus 120 can mix essential oil from the container 95 with water from the source 40 or an alternative source 96.

Two separate mixers 44 and 97 are preferable for generating the two mists.

It is also possible to authorise essential oil treatments and keep track of them by means of corresponding means of recognition 73b associated with the essential oil container 95 and a reader device 74b, in the same way as biosolution containers.

Following treatments conveniently allow not only the destruction of the favourable environment for mites to develop, but also the killing through essential oils of already existing mites that might survive the treatment with microorganisms. This, more conveniently, does not harm further treatments with microorganisms.

### GENERAL MEANING OF TERMS

In understanding the purpose of the present invention, the term “comprising” and its derivatives, as used herein, are intended as open-ended terms specifying the presence of the declared characteristics, elements, components, groups, integers and/or phases, but not excluding the presence of other undeclared characteristics, elements, components, groups, integers and/or phases. The above also applies to words with similar meanings such as the terms “including”, “having” and their derivatives. In addition, the terms “part”, “section”, “portion”, “member” or “element” when used in the singular may have the dual meaning of a single part or a plurality of parts. As used herein to describe the form(s) of implementation mentioned above, the following directional terms “forward”, “backward”, “above”, “below”, “vertical”, “horizontal”, “underneath” and “transverse”, as well as any other similar directional terms refer to the form of implementation described in the operative position. Finally, grade terms such as “substantially”, “about” and “approximately” as used herein mean a reasonable amount of deviation of the modified term such that the end result is not significantly changed.

While only selected implementation forms have been chosen to illustrate the present invention, from this description it will be clear to those experts in the field that various modifications and variations may be made without departing from the purpose of the invention as defined in the attached claims. For example, the size, shape, position or orientation of the various components may be modified as needed and/or desired. Components shown directly connected or in contact with each other may have intermediate structures interposed between them. The functions of one element can be performed by two and vice versa. The structures and functions of one form of implementation can be adopted in another one. It is not necessary that all advantages are present in a particular form of implementation at the same time. Each characteristic that is original compared to the prior art, alone or in combination with other characteristics, should also be considered a separate description of further inventions by the applicant, including structural and/or functional concepts incorporated by those characteristics. Therefore, the previous descriptions of implementation forms according to the present invention are provided for illustrative purposes only and not for the purpose of limiting the invention as defined by the attached claims and their equivalents.

1. Volatile pollutant abatement process comprising the following steps:
providing a confined environment containing the pollutants to be abated at least in volatile form; and
conveying a plurality of microorganism into the confined environment using a dry mist produced by molecular fragmentation as a vector.

2. (canceled)

3. Process according to claim 1, characterised by the fact that the dry mist has a micrometric particle size of substantially 5 microns or less.

4. Process according to claim 1, characterised by the following steps:
providing at least a sealed biosolution container and a water source, where the biosolution includes said microorganisms suspended in a liquid containing at least their nutrients; and
opening the container and mixing the said biosolution and the said water substantially at the time when generating said mist.

5. Process according to claim 4, characterised by treating said water exposing it to at least one electromagnetic field before said mixing.

6. Process according to claim 4, characterised by treating said water before said mixing in order to obtain hydrogenated water.

7. Process according to claim 4, characterised by treating said water before said mixing by bringing it to a temperature of 20°to 40°C.

8. (canceled)

9. Process according to claim 4, characterised by the fact that the sealed container comprises means of recognition, including a QR code, and a first sealed container is processed wherein: a—mist production is permitted by the reading of such means of recognition; b—the reading of said means of recognition generates a treatment record in a treatment register; and c—following treatments are carried out by replacing the used container with respective sealed containers and repeating steps a and b.

10. Process according to claim 1, characterised by diffusing the mist by means of an air flow and heating said air flow up to a temperature of 20°to 40°C.

11. Process according to any claim 1, characterised by the fact that said step of conveying the plurality of microorganisms is carried out at least during the presence of living beings at the site.

12. Process according to claim 1, characterised by diffusing the mist by means of a sanitised air flow.

13. Process according to claim 1, characterised by carrying out in succession at least two treatments of said confined site with two respective different products using said dry mist as their vector, wherein the first treatment uses said microorganisms as a product and the second treatment uses at least one essential oil as a product.

14. Apparatus for abatement of volatile pollutants, comprising means of producing a dry mist by molecular fragmentation containing microorganisms.

15. (canceled)

16. Apparatus according to claim 14, comprising
at least one mist generating device;
at least one water source to feed the mist generating device;
at least one sealed biosolution container containing predetermined microorganisms that can be coupled and decoupled from the mist generating device;
sealed container opening means;
mixing means of water and biosolution operationally interposed between the water source and the sealed container on the one hand and the mist generating device on the other hand.

17. Apparatus according to claim 16, comprising
a plurality of sealed containers each comprising recognition means;
reading means of recognition means;
consent means for mist production operationally connected to the reading means; and
means of recording the treatments carried out operationally related to the reading means.

18. Apparatus according to claim 14, comprising a forced—air mist ejection line—, wherein said line comprises a mist containment compartment interposed between an outlet from the compartment and an ejection fan, the outlet and the fan are placed in the upper part of the compartment, while the dry mist generator is placed in the lower part in such a way that the outlet of the mist pushed by the flow of the fan generates a depression which sucks the lighter and therefore more volatile mist particles from the compartment.

19. Apparatus according to claim 18, comprising an air sanitising section on the upper part of the ejection fan.

20. Apparatus according to claim 18, comprising air heating means on the upper part of the said ejection fan.

21. Apparatus according to claim 14, comprising water electromagnetic treatment means before mixing with said biosolution.

22. Apparatus according to claim 14, comprising water hydrogenation treatment means before mixing with said biosolution.

23. Apparatus according to claim 14, comprising at least one essential oil container operatively connected to said mist generating means, wherein said apparatus comprises operating means set up to alternatively and successively produce a mist comprising said microorganisms and a mist comprising at least one essential oil.

24. (canceled)

25. (canceled)
